(19) United States
(12) Patent Application Publication
(10) Pub. No.: US 2010/0000221 A1
(43) Pub. Date: Jan. 7, 2010

(54) Method for producing fuel and power from a methane hydrate bed using a gas turbine engine

(76) Inventor: William C. Pfefferle, Madison, CT (US)

Correspondence Address: Robert L. Rispoli;Precision Combustion, Inc., 410 Sackett Point Road, North Haven, CT, 06473, US

(21) Appl. No.: 12/012,397

(22) Filed: Jan. 31, 2008

Related U.S. Application Data
(60) Provisional application No. 60/926,952, filed on Apr. 30, 2007.

(51) Int. Cl. F02C 3/28; E21B 43/16

(52) U.S. Cl. 60/772; 60/783; 60/39.5; 166/305.1

(57) ABSTRACT

A method of producing natural gas fuel from gas hydrate beds is provided wherein a gas turbine engine is operated thereby producing power and hot exhaust. A portion of the heat from the hot exhaust is transferred to water and the heated water is passed downhole and brought into thermal contact with a hydrate bed thereby dissociating hydrate and producing hydrate gas. Sufficient fuel is then passed to the engine for operation.

### CROSS-REFERENCE

This application claims the benefit of U.S. Provisional Application No. 60/926,952 filed Apr. 30,2007.

### BACKGROUND OF THE INVENTION

1. Field of the Invention

The present invention relates to an integrated method for the production of electrical power and natural gas from methane hydrate deposits. More particularly, the present invention is directed to the release of methane from methane hydrates using exhaust heat from an engine operating on produced methane.

2. Description of the Related Art

Methane hydrate deposits are abundant throughout the world and have been estimated to represent by far the greater portion of the world's fossil energy reserve. Within the United States alone, methane hydrates represent an estimated 200,000 Trillion cubic feet (Tcf) of the total 227,500 Tcf of known natural gas reserves. The methane hydrate deposits, occurring at great depths primarily in the oceans, dwarf the total known combined oil and non-hydrate gas reserves. With the United States largely dependent upon imported fuels, there is an urgent need for a method to economically produce natural gas from the abundant United States methane hydrate reserves. Unfortunately, it has not yet been demonstrated that methane can be economically recovered from methane hydrates. Two approaches are possible; mining and in-situ dissociation.

For in-situ dissociation, three approaches exist. One method involves heating the methane hydrate. This requires only about ten percent of the trapped gas heating value, assuming no heat losses. However, for below-ocean deposits, it has been found that pumping a heated fluid from the surface to the methane hydrate deposit results in such a high heat loss that essentially all of the heating value of the recovered methane is consumed to supply the needed energy for hydrate dissociation. Improved insulated piping can significantly reduce heat loss. Regardless, for deep deposits the heat loss in transit downhole of hot fluids from the surface is typically unacceptable. In-situ combustion would minimize such transit heat losses but would be difficult to establish in a hydrate bed. Downhole catalytic combustion offers a solution but has yet to be proven economic.

A second method for in-situ dissociation involves reducing the in-situ pressure to a value below the methane hydrate dissociation pressure. However, the dissociation energy must still be supplied to the formation. Consequently, the methane hydrate formation temperature decreases thereby requiring even lower pressures for dissociation reducing gas flow to uneconomic levels. Accordingly, this approach typically requires mining the solid methane hydrates and pumping slurry to the surface. Such a mining system has yet to be demonstrated to be economically feasible.

Another method for in-situ dissociation involves pumping carbon dioxide downhole to displace methane from the methane hydrates by formation of carbon dioxide hydrates. However, this method has not been demonstrated as feasible as the reaction is slow at the deposit temperatures. In addition, conditions in a stable hydrate bed are appropriate for the formation of new methane hydrate from methane and water. Again, it is important in this method to raise the temperature of the deposit to minimize the reformation of methane hydrates.

### SUMMARY OF THE INVENTION

It has now been found that burning produced gas in an on-site engine to generate electricity generates enough waste heat to produce all the natural gas needed for the engine, even with otherwise unacceptably high heat loss in transport downhole. Inasmuch as only about ten percent of the heat of combustion is needed to decompose methane hydrate, even a sixty percent efficient combined cycle gas turbine liberates for use forty percent of the fuel heating value for dissociation. A seventy five percent loss is therefore acceptable to produce the natural gas fuel required.

In a system of the present invention, gas turbine exhaust is passed to a gas-to-water heat exchanger producing heated water. Note that with low available water temperature, even some of the latent heat in the exhaust gas water vapor can be recovered. Advantageously, the heated water is passed downhole via an injection well having insulated tubing. The injection well may have multiple side branches for optimum distribution of the heated water. Liberated gas is produced through a production well.

With less efficient gas turbines, gas production can greatly exceed that needed for turbine operation and delivered to market by pipeline or as Liquefied Natural Gas (LNG). Electricity produced is readily transported using state of the art transmission systems. Under water cables are known in the art. Note that electricity typically has at least triple the value of the gas consumed. For remote locations, the electrical power can be used either to liquefy gas for export as LNG or converted on-site to desired products such as diesel fuel using available technology.

Capturing the CO₂ produced is readily accomplished by reforming the fuel before combustion and separating the CO₂ as with coal or by burning the fuel using oxygen. Such systems are available for CO₂ recovery. Such CO₂ could be injected into the hydrate bed for sequestration and enhanced methane production or delivered to an oil field to enhance oil production. Advantageously, the system includes and air separation plant to supply oxygen to the gas turbine for fuel combustion. In this case carbon dioxide is readily recovered for injection downhole for either natural gas production or enhanced oil recovery. A portion of the carbon dioxide is supplied to the gas turbine mixed with the oxygen for fuel combustion.

System start up is readily accomplished using gas obtained by hydrate reservoir depressurization.

### BRIEF DESCRIPTION OF THE DRAWING

FIG. 1 is a schematic drawing of a gas turbine system according to the present invention.

### DETAILED DESCRIPTION OF THE DRAWING

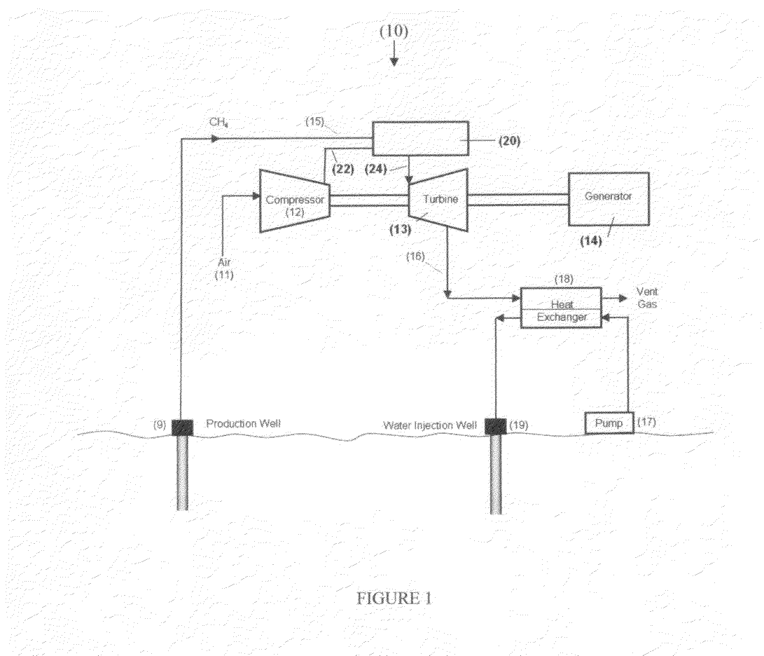

As shown in FIG. 1, a gas turbine system 10 according to the present invention comprises a supply of air 11 that is fed to a compressor 12. A supply of and methane fuel 15 and a stream of compressed air 22 are fed to a combustor 20 and the hot gas product stream 24 is fed to a turbine 13 that, in turn, is connected to a generator 14. Turbine exhaust 16 is fed to a heat exchanger 18 heating sea water from pump 17 before injection into a hydrate bed via injection well 19. Gas liberated by thermal decomposition of hydrate is recovered via well 9 is passed to the engine for operation. Excess gas, not shown, is exported.

Although the invention has been described in considerable detail, it will be apparent that the invention is capable of numerous modifications and variations, apparent to those skilled in the art, without departing from the spirit and scope of the invention.

What is claimed is:

1. A method of producing natural gas fuel from gas hydrate beds comprising:
a) operating an engine producing power and hot exhaust;
b) transferring at least a portion of the heat from the hot exhaust to water;
c) passing heated water downhole and into thermal contact with a hydrate bed;
d) dissociating hydrate and producing hydrate gas; and
e) passing sufficient fuel to the engine for operation.

2. The method of claim 1 wherein the engine is a gas turbine.

3. The method of claim 1 wherein the power drives an electrical generator.

4. The method of claim 3 wherein both electricity and gas are exported.

5. The method of claim 1 wherein a portion of the power is utilized for liquefaction of the produced natural gas.

6. The method of claim 1 wherein carbon dioxide is recovered from the exhaust gas.

7. A system for recovery of energy from a methane hydrate bed comprising:
a) a gas turbine;
b) an electrical generator;
c) a heat exchanger to transfer heat from the turbine exhaust to water;
d) an injection well to deliver heated water to a hydrate deposit;
e) a gas production well to deliver natural gas to the gas turbine.

8. The system of claim 7 wherein the injection well is thermally insulated.

9. The system of claim 7 wherein CO₂ is recovered from the fuel before combustion.

10. The system of claim 7 further comprising an oxygen plant to provide oxygen for combustion in the gas turbine combustor.

11. The system of claim 10 further comprising a compressor for compressing the combustion carbon dioxide for injection downhole for gas and or oil production.

12. A method of producing electrical power from a hydrate deposit comprising:
a) operating a gas turbine producing electrical power and hot exhaust;
b) transferring at least a portion of the heat from the hot exhaust to water;
c) passing heated water downhole through an injection well and into thermal contact with a hydrate bed;
d) dissociating hydrate and producing hydrate gas;
e) extracting gas through a production well; and
f) passing sufficient fuel to the gas turbine for operation.

13. The method of claim 12 wherein excess methane is produced.

14. The method of claim 12 wherein carbon dioxide is recovered from the gas turbine exhaust gas.

15. The method of claim 14 wherein oxygen is used for gas turbine combustion.

16. The method of claim 12 wherein the injection well has multiple branches to distribute the heated water to the hydrate deposit.
